(19) United States
(12) Patent Application Publication
(10) Pub. No.: US 2013/0148368 A1
(43) Pub. Date: Jun. 13, 2013

(54) METHOD AND DEVICE FOR CONTROLLING A LIGHT EMISSION FROM A HEADLIGHT OF A VEHICLE

(71) Applicant: Johannes FOLTIN, Ditzingen (DE)

(72) Inventor: Johannes FOLTIN, Ditzingen (DE)

(21) Appl. No.: 13/705,728

(22) Filed: Dec. 5, 2012

(30) Foreign Application Priority Data
Dec. 9, 2011 (DE) 10 2011 088 136.0

(51) Int. Cl. B60Q 1/08

(52) U.S. Cl. CPC B60Q 1/08
USPC 362/466; 362/465

(57) ABSTRACT

A method for controlling a light emission from at least one headlight of a vehicle combines lane information with respect to a course of a road and position information with regard to at least one other vehicle located in the course of the road, in order to ascertain an envelope area not to be illuminated around the at least one other vehicle. The method also includes setting, based on the envelope area, a safety distance between (i) light able to be emitted by the at least one headlight of the vehicle, and (ii) the at least one other vehicle, in order to control the light emission.

### BACKGROUND OF THE INVENTION

1. Field of the Invention

The present invention relates to a method and a device for controlling a light emission from at least one headlight of a vehicle, as well as a corresponding computer-program product.

2. Description of the Related Art

Glare-free high beam, also known as continuous headlight control, CHC, pursues the idea of illuminating the surrounding field in front of a vehicle continuously at night with high beam, and to make only those areas “non-luminous” in which other vehicles are located. The difficulty lies, inter alia, in not blinding any other vehicle.

Published European patent application document EP 2 165 882 A1 describes a method for regulating the light output by motor-vehicle headlights.

### BRIEF SUMMARY OF THE INVENTION

The present invention is based on the knowledge that a safety distance is able to be set between the light produced by a vehicle headlight, and at least one other vehicle, on the basis of information about the course of the road, as well as information about a position of the other vehicle in the course of the road. Using this information, an envelope area surrounding the at least one other vehicle may be ascertained, the envelope area to be excepted from, i.e., not to be illuminated by, the light of the at least one headlight. Thus, a safety distance to the other vehicle is able to be set with regard to the lighting, taking into account the envelope area not to be illuminated.

An advantage of the present invention is that it is possible to set the safety distance in the lighting in such a way that an advantageous balance may be achieved between glare prevention and optimal visual range. Traffic safety may thus be increased, since blinding of a driver of the other vehicle is avoided, and road illumination may be improved. Since the envelope area takes into account the course of the road as well as the position of the other vehicle in the course of the road, a foresighted setting of the safety distance, adapted to the instantaneous course of the road and therefore precise and reliable, is possible. According to one specific embodiment, the envelope area or an envelope curve defining the envelope area is able to be calculated exclusively from camera data that may include object data and lane information. According to an alternative specific embodiment, data of the navigation device may be used in addition to the camera data.

The present invention provides a method for controlling a light emission from at least one headlight of a vehicle, the method having the following steps:

Combining lane information with regard to a course of a road and position information regarding at least one other vehicle located in the course of the road, in order to ascertain an envelope area not to be illuminated around the at least one other vehicle; and

Setting a safety distance between light able to be emitted by the at least one headlight of the vehicle, and the at least one other vehicle based on the envelope area, in order to control the light emission.

The vehicle may be a motor vehicle, especially a road-bound motor vehicle, e.g., a passenger car or a truck, or a two-wheeler such as a motorcycle. The at least one headlight may be a front headlight of the vehicle, for example. The light emission from the at least one headlight may be alterable in steps. For the control, the light emission from the at least one headlight may be altered in terms of an illumination angle, a light distribution pattern, a brightness, a quantity of light, a level of illumination, a headlight range, a light/dark cutoff and/or the like. Suitable values for the illumination angle, light distribution pattern, brightness, quantity of light, level of illumination, headlight range, light/dark cutoff and/or the like may be selected which make it possible to set the safety distance in such a way that the envelope area around the at least one other vehicle is excepted from the light of the at least one headlight. In this context, the envelope area may surround the at least one other vehicle or may have a surrounding area adjoining the at least one other vehicle. In this connection, the envelope area may represent a safety area which should be excepted from illumination by the at least one headlight. The vehicle may be on the road and may be following the course of the road. If a cyclist is in a bicycle lane next to the road, the cyclist should also not be blinded. In the same way, other vehicles which are driving on a bridge over the road should be considered. That is, the roads in the surround field or field of view of the vehicle or of the course of the road may also be considered, not just the road on which the vehicle is located. The course of the road may thus also include roads forking off from the road. Generally expressed, the course of the road may include an area able to be illuminated by the headlight.

In this context, in the step of combining, the envelope area may additionally be ascertained from an alignment of the at least one other vehicle relative to the host vehicle. A step of estimating the alignment based on the lane information and the position information may also be provided. The alignment may involve a relationship between a longitudinal axis of the at least one other vehicle, for example, and a longitudinal axis of the host vehicle. The more the alignment of the at least one other vehicle differs from an alignment of the vehicle, the larger at least one dimension of the envelope area can be ascertained. In an estimation or other determination of the alignment, a most probable alignment may be determined or several probable alignments may be determined, through which an average value of the several probable alignments may then be formed. The formation of a weighted sum of the possible alignments as a function of their probabilities is advantageous when ascertaining the most probable alignment. Such a consideration of the alignment of the at least one other vehicle offers the advantage that the envelope area, and therefore also the safety distance, may be adjusted more correctly to a probable orientation of the at least one other vehicle. Thus, illumination of the road as well as prevention of blinding may be improved.

In this context, in the step of setting, at least one lateral section of the safety distance located to the side of the at least one other vehicle may additionally be set based on the alignment. A change in an alignment of the at least one other vehicle may lead to an altered setting of the safety distance in a lateral section of the safety distance located to the side of the at least one other vehicle. If the alignment of the at least one other vehicle corresponds essentially to an alignment of the vehicle, the safety distance may be set in such a way that the lateral section of the safety distance has a minimum dimension. If the alignment of the at least one other vehicle deviates increasingly from the alignment of the vehicle, the safety distance may be set in such a way that the lateral section of the safety distance has an increasingly larger dimension. Such a specific embodiment offers the advantage that the safety distance may be adjusted with improved accuracy to a probable alignment of the at least one other vehicle. In this context, the lateral section of the safety distance may be set to a smallest possible dimension as a function of the alignment. Thus, illumination of the road as well as prevention of blinding may be improved.

The method may include a step of ascertaining the lane information and the position information based on data from a camera of the host vehicle. The step of ascertaining lane information may be carried out prior to generating a digital representation of the course of the road.

Thus, in the step of combining, a digital representation of the course of the road may be generated. In this case, the envelope area may be determined using the digital representation. The digital representation of the course of the road may be generated based on the lane information. Such s generation and use of a digital representation offers the advantage that the position of the at least one other vehicle in the course of the road, and therefore also the envelope area, may be ascertained more reliably and with greater accuracy. Thus, illumination of the road as well as prevention of blinding may be improved. The digital representation may include data corresponding to a digital map. Map data of a navigation device may also be used, in doing which, a content of the map data may be copied out of the map data, for example, for utilization in the method. By generating the digital representation, a virtual map may be produced by a sensor-data fusion. Such a sensor-data fusion may be performed as an option in the implementation of the method. However, it is also possible to react exclusively to the course of the road measured by the camera, or navigation-device map data already prepared may be used exclusively. If the step of generating a map is not carried out, then instead, the method may be based on camera data, thus, for example, a course of the road or a lane course measured directly by the camera. For example, the course of the road may be calculated relative to the host vehicle at the position of the other vehicle.

In the step of combining, potential placements of the at least one other vehicle may be determined based upon the lane information. In this case, the envelope area may be ascertained using the potential placements. For example, the envelope area may be determined based upon potential placements of the other vehicle based upon the lane information. According to one specific embodiment, pure lane courses may be used as lane information without the necessity of an intermediate step of generating a digital representation or a digital map. According to one specific embodiment, another road user may be recognized and its position information ascertained based upon data from a camera of the host vehicle. Moreover, lane information is determined based upon data from the camera. Depending on the course of the road, e.g., an S-curve, it may be that the other vehicle could be positioned at two or more different spots in the lane course. However, no intermediate step via a digital representation is necessary. According to one alternative specific embodiment, in the step of combining, potential placements of the at least one other vehicle may be determined on a digital representation of the course of the road. In this instance, the envelope area may be ascertained using the potential placements on the digital representation. The potential placements may relate to an orientation, alignment, position, direction of travel, speed, etc. of the at least one other vehicle in terms of the digital representation and/or lane information, as well as of the host vehicle. Such a specific embodiment offers the advantage that the position of the at least one other vehicle in the course of the road, and therefore also the envelope area, may be ascertained more reliably and with greater accuracy. Thus, illumination of the road as well as prevention of blinding may be improved. An advantage of an optional generation of map data lies in the abstraction of the measurement data, and therefore good interchangeability and expandability with other sensors or measuring concepts. However, if no map is generated and lane information is evaluated exclusively, it is possible to dispense with the map representation, thereby making it possible to save resources on the control device.

In addition, a step of determining the lane information and/or the position information based upon image data and/or navigation data and/or driving data of the host vehicle may be provided. Consequently, the lane information may be determined based upon image data and additionally or alternatively, based upon navigation data. The lane information may be determined from the image data with the aid of suitable image processing, object recognition, pattern recognition or the like. The position information, thus, the position of the other vehicle relative to the host vehicle, defined by angle of sight and distance, for instance, and additionally or alternatively, the lane information, may be determined using the navigation data and/or information from image data. The relative position of the other road users may be determined advantageously via the camera. The position evaluation based exclusively on navigation information requires a communication between the vehicles, the other vehicle communicating its position to the vehicle. According to one specific embodiment, the position of other road users is able to be detected only via the camera. The lane information may be ascertained from the data of the video camera, e.g., the data of a lane detection. Such a determination of the lane information offers the advantage that the lane information may be determined reliably and accurately. It is also possible to ascertain the lane information from the navigation data, e.g., the map data and the position of the host vehicle on it. In addition, there is also the possibility of determining the plausibility of the lane information, if both image data and navigation data are taken as a basis. In this connection, besides the actual position determination supported by satellite, for example, the associated navigation-map data and/or the associated electronic horizon may also be understood as navigation data. The electronic horizon is a section from the data of the navigation-map data, on which in all probability, the vehicle will move. Depending on the system design, the navigation data may represent roads in a certain vicinity around the host vehicle. With regard to the driving data, a potential course of the road may be estimated, for example, based on the yaw rate and the speed or the steering-wheel angle. Thus, the method may include a step of determining the lane information and/or the position information based upon image data. The image data may be data from a camera of the vehicle.

Additionally or alternatively, the method may include a step of determining the lane information and/or the position information based on navigation data. Additionally or alternatively, the method may include a step of determining the lane information and/or the position information based on driving data of the vehicle.

In the step of setting, the safety distance may be set based on the envelope area and a plausibility of the lane information. In this context, the plausibility may be high if the lane information is able to be determined or measured with great accuracy. The plausibility may be low if the lane information is estimated. Furthermore, a step of estimating the lane information may be provided. An estimation of the lane information may be necessary if, for instance, the other vehicle is outside of the lane-detection range of the camera, or if, for example, because of the lack of lane marking, the lane course cannot be measured with sufficient reliability or cannot be measured at all. Low plausibility of the lane information may be caused by an inaccurate measurement. Plausibility may also be low if, for example, both data from the camera and navigation data are used and there are differences between them, e.g., in the case of changes in the course of the road which, owing to the age of the navigation data, are not present in that data. If the plausibility of the lane information is low, in the setting step, the safety distance may be provided with an enlargement factor. Such a specific embodiment offers the advantage that, even in the case of only inexactly determinable lane information or lack of determinability of the lane information, a suitable safety distance may be set, so that blinding of other vehicles may continue to be avoided and the best possible visual range may be maintained. Plausibility may be high, for example, if the other vehicle is close to the vehicle, and lane information of high quality, e.g., from a combination of camera data and instantaneous navigation data is available in this area. It is possible that the lane information exists, but is really unreliable. For instance, this is the case if the lane marking is very far away, several markings lie one upon the other (e.g., in a construction site) or the quality of the markings is poor. An estimate of the lane course is then not necessary; however, because of the poor quality, a larger envelope area is sensible. Therefore, the envelope area may be ascertained as a function of a quality and/or plausibility of the lane information.

According to one specific embodiment, a step of ascertaining the lane information with respect to the course of the road may be provided. A step of receiving the position information with regard to the at least one other vehicle located in the course of the road may also be provided. The image data may be generated with the aid of a vehicle camera or other image recording device and be received by an interface to the vehicle camera or other image-recording device. The position information may be received by an interface to a vehicle camera or other image recording device or a navigation device or other mobile data-transmission device. Such a specific embodiment offers the advantage that, in this manner, instantaneous lane information and position information may also be available for controlling the light emission and setting the safety distance.

The method may include a step of determining the plausibility or improving the position information based upon movement data of the other vehicle. According to one specific embodiment, in the step of combining and/or of determining, movement data of the host vehicle and/or of the other vehicle may additionally be used to advantage to more precisely determine or to check the plausibility of the ascertained position and alignment and/or to adjust an envelope curve according to the movement data of the other vehicle. Movement data of the other vehicle may be understood to be the movement of the other vehicle relative to the vehicle.

The present invention further provides a device for controlling a light emission from at least one headlight of a vehicle, the device being designed to carry out or implement the steps of the method according to the invention. In particular, the device may have units which are designed to carry out one step of the method each. The object of the present invention may be achieved quickly and efficiently by this embodiment variant of the invention in the form of a device, as well.

Roads are generally marked with lane markings. Under the term roadway course, one may understand a lane or traffic lane in which the host vehicle or the other vehicle is located. A roadway course is often bounded left and right by lane markings. A course of a road is made up of at least one roadway course, frequently at least one roadway course being provided for each travel direction, which usually run parallel to each other. A camera, which records and evaluates an image of the surround field in which a course of a road is located, is able to recognize the lane markings as such and identify them as lane course. The roadway course may be inferred from the lane course. The lane course, as well as—building on this—the roadway course and the course of the road may be represented internally, for example, as a clothoid relative to the vehicle. The lane course, which, for example, is detected by a camera, is usually shorter than the entire associated lane marking, since the camera has only a limited detection range which is generally smaller than the length of the lane marking.

If no lane markings are present or they are not recognized as lane course, the driving course and therefore the roadway course already traveled over may be ascertained from the movement of the host vehicle. For example, the yaw rate, speed and steering-wheel angle may be used for that purpose. Assuming that only small changes of the radius traveled at any point in time occur, from the radius of the specific point in time, i.e., from the roadway course already traversed, it is possible to estimate the future roadway course. Estimating the roadway course without lane markings is not as accurate as ascertaining the roadway course with lane markings lying in front of the host vehicle. The linkage of the roadway course already traveled, with detected lane courses (885) is advantageous in order to estimate the roadway course more accurately.

The course of the road may also be gathered from map information of navigation devices, for example. The course of the road may be gathered directly from the navigation data. In turn, the roadway course may be inferred from the course of the road, particularly if the number of lanes is available in the navigation data, or is able to be estimated by the camera.

The use of the course of the road directly from the navigation data has the advantage that a generally greater projection is attained than in the case of the measurement by a video camera. Having a negative effect—in addition to the accuracy of the course of the road in the navigation data—is also the age of the map material, since the course of the road may be altered due to construction, which often is not up to date in the navigation data.

In ascertaining the course of the road from navigation data, further roads which run in parallel or transversely to the roadway, for example, and which at night can sometimes only be detected poorly or late with the camera, may be ascertained in anticipation.

Lane information may be understood as a roadway course, course of a road and/or lane course. For example, the lane information may be ascertained with a video camera, from navigation data and/or data of the vehicle dynamics (driving data), as well as a combination of different data sources, in doing which, an intermediate step via an internal map representation is possible.

The lane information is not limited to the course of the road on which the vehicle is moving, but rather, may also relate to another road course that does not necessarily run parallel to the course of the roadway of the vehicle. In this manner, the alignment of the other vehicle is able to be ascertained sufficiently accurately even in the case of roads running next to the roadway (e.g., bicycle path) and transversly to the roadway (e.g., a bridge over the road or an intersection). It is advantageous to limit the lane information to a certain radius around the vehicle which may be on the order of magnitude of the detectability distance of the other road users, thereby making it possible to save on computing time.

The lane information, particularly the roadway course, may be used advantageously to ascertain the necessary envelope curve and to adjust the light distribution pattern. One may assume that the vehicles are moving parallel to the roadway course in the lane. For example, the alignment may be ascertained from the position of the other vehicle in the lane. The knowledge of the exact allocation of the other vehicle to the respective roadway course is advantageous, particularly if several lanes are present for one driving direction.

The lane courses which are able to be detected by the camera are subject to measuring fluctuations, particularly in the long range. Depending on the representation of the lane courses, e.g., via a clothoid relative to the vehicle, further inaccuracies ensue. The actual roadway course may be estimated more precisely by evaluating the measured lane information (e.g., the lane courses) over a certain period of time. To that end, for example, the measured lane information may be entered into a digital map which may be stored in volatile or non-volatile manner. The representation of the lane information in a vehicle-independent format proves to be especially advantageous, since the host vehicle is moving in the traffic lane and may also make lane changes. The advantage of using a digital map is a certain sensor independence, which means an exchange or an expansion is simplified. The sensor-data fusion of camera data with navigation data in a digital map is especially advantageous, in order to increase the availability and the accuracy of the data.

In the event of great fluctuations in the measuring data, the plausibility of the lane information may be reduced. In this case, a solution is to enlarge the envelope curve, in order not to blind the other road user.

If navigation data is available in the vehicle, the lane data may be linked advantageously with the navigation data. The storage and linkage of the lane information in one common digital representation in the form of a digital map presents itself here, as well.

Position information of the other vehicle may be understood, for example, to be information about a relative position, e.g., direction and distance, of the other vehicle with respect to the vehicle.

Accuracy may be increased by evaluating the movement information of the other vehicle. For example, if there are several potential placements of the other vehicle in the lane information, the most probable placement and therefore the alignment of the other vehicle may be ascertained by evaluating the movement data. Thus, for example, in S-shaped curves (also called “S-curve”), in which there are at least two possible placements, the correct positioning, alignment and therefore also the appropriate envelope area may be ascertained in reliable fashion.

In the same way, it is possible to increase the plausibility check of the lane information using the movement data. For instance, in a long range in which the lane information exhibits low plausibility owing to measuring inaccuracy, the movement data of the other vehicle is able to provide fortification, thus increasing the plausibility.

In another specific embodiment, the movement data of the other vehicle may be used to ascertain a low plausibility of the lane information if the movement data cannot be accounted for with the lane information. An enlargement of the envelope area is then advantageous.

In the present case, a device may be understood to be an electrical device or control device which processes sensor signals and outputs control signals as a function thereof. The device may have an interface which may be implemented in hardware and/or software. In the case of a hardware implementation, the interfaces may be part of what is termed a system ASIC, for example, that includes a wide variety of functions of the device. However, it is also possible that the interfaces are separate integrated circuits or are made up at least partially of discrete components. In the case of a software implementation, the interfaces may be software modules which, for example, are available in a microcontroller in addition to other software modules.

A lighting system for a vehicle may also be provided, the lighting system having at least one headlight of the vehicle and the above-indicated device for controlling a light emission from the at least one headlight.

Also advantageous is a computer-program product having program code which is stored in a machine-readable medium such as a semiconductor memory, a hard-disk storage or an optical memory, and is used to implement the method according to one of the specific embodiments described above when the program is executed in a device.

### BRIEF DESCRIPTION OF THE DRAWINGS

FIGS. 1 to 2F show schematic representations of various emission characteristics of vehicle headlights.

FIG. 3 shows a flow chart of a method according to one exemplary embodiment of the present invention.

FIG. 4 shows a schematic representation of a vehicle having a control device according to one exemplary embodiment of the present invention.

FIGS. 5 to 8 show camera images recorded by a vehicle camera.

FIG. 9 shows a flow chart of an algorithm according to one exemplary embodiment of the present invention.

### DETAILED DESCRIPTION OF THE INVENTION

In the following description of preferred exemplary embodiments of the present invention, the same or similar reference numerals are used for the similarly functioning elements shown in the various figures, a repeated description of these elements being omitted.

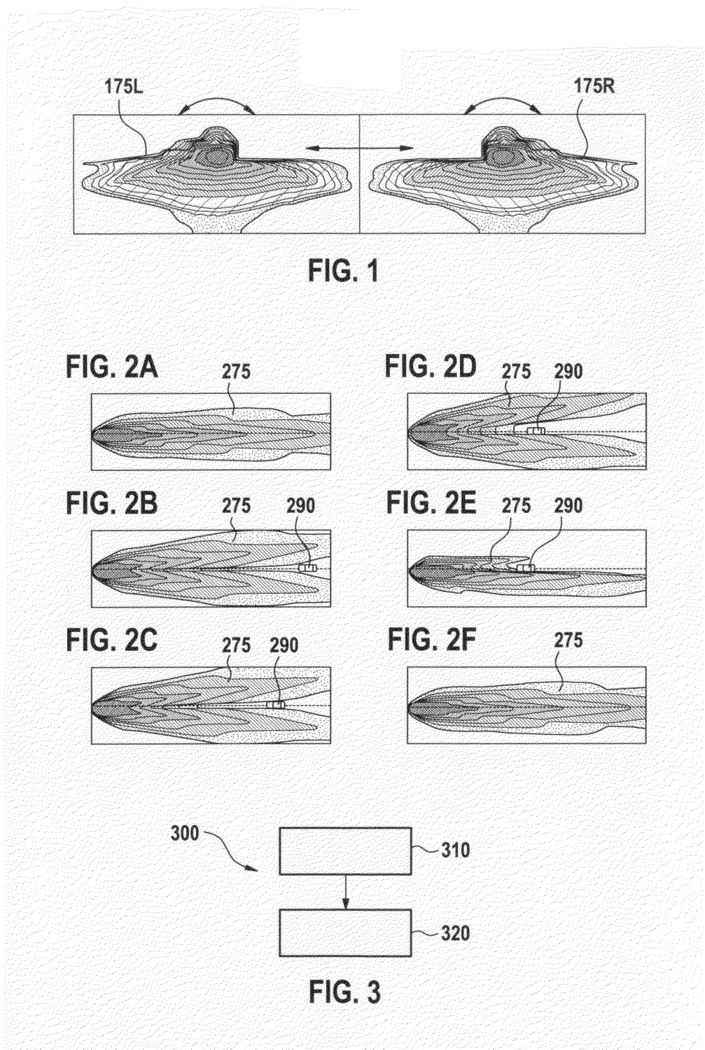

FIG. 1 shows a schematic representation of emission characteristics of a pair of vehicle headlights. In particular, FIG. 1 shows one possible realization of a glare-free high beam. Shown are a first emission characteristic 175L or first light distribution pattern and a second emission characteristic 175R or second light distribution pattern. First emission characteristic 175L may be assigned to a first headlight of a vehicle, e.g., a left headlight. Second emission characteristic 175R may be assigned to a second headlight of the vehicle, e.g., a right headlight. Arrows in FIG. 1 indicate areas in which emission characteristics 175L and 175R are modified in such a way that the areas indicated by the arrows are excepted or excluded from the light distribution pattern. The positions of the two light distribution patterns may be altered by swiveling, for example, which means a (partial) superposition of the light distribution patterns is also possible. If different light distribution patterns are superposed, new light distribution patterns are able to be produced from that, which may be used, for example, to realize a glare-free high beam. In a schematic view, emission characteristics 175L, 175 may in each case be depicted red in the center, and then outwardly through orange, yellow, green, blue according to the spectral colors, up to violet in the outermost ring.

FIGS. 2A through 2F show schematic representations of various emission characteristics 275 of vehicle headlights. In particular, FIGS. 2A though 2F show one possibility for realizing a glare-free high beam from the bird's-eye perspective. Emission characteristics 275 are represented as light distribution patterns or ranges or headlight levels or luminous-intensity curves of vehicle headlights. To be precise, the different emission characteristics 275 may be adjusted with the aid of a high-beam assistant, e.g., using Continuous Headlight Control (CHC). In FIGS. 2A through 2F, emission characteristics 275 are each produced by headlights of a vehicle (not shown explicitly), such a vehicle being located in each case at a left margin of the images in FIGS. 2A through 2F. Emission characteristics 275 have a light distribution pattern, i.e., a profile of light intensities.

FIGS. 2B through 2E also show another vehicle 290. In the progression of the figures from 2B to 2E, other vehicle 290 is at an increasingly smaller distance relative to the vehicle producing emission characteristics 275. In this context, emission characteristics 275 are in each case adjusted in such a way that other vehicle 290 is located outside of the light distribution pattern of the vehicle headlights, that is, is excepted from the light distribution pattern.

In a schematic view, emission characteristics 275 in the center shown to the left may in each case be depicted red, and then outwardly through orange, yellow, green according to the spectral colors, up to blue in the outermost edge.

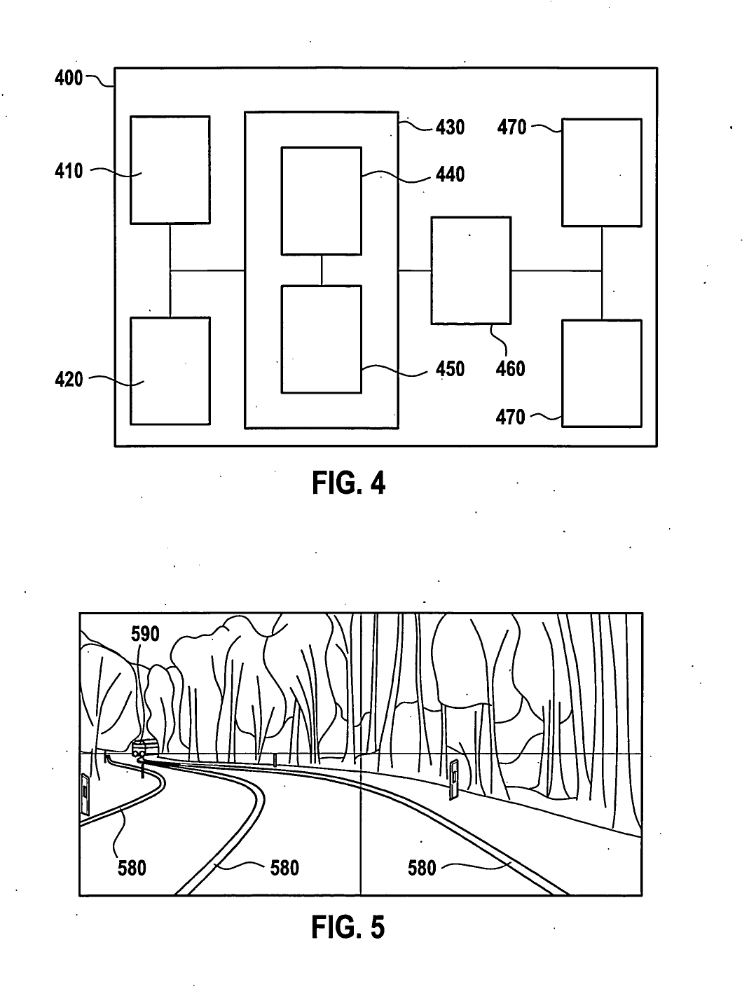

FIG. 3 shows a flow chart of a method 300 for controlling a light emission from at least one headlight of a vehicle according to one exemplary embodiment of the present invention. Method 300 has a step of combining 310 lane information with respect to a course of a road on which the vehicle is presently located, and position information with regard to at least one other vehicle located in the course of the road, in order to ascertain an envelope area not to be illuminated around the at least one other vehicle. Method 300 also has a step of setting 320 a safety distance between light able to be emitted by the at least one headlight of the vehicle, and the at least one other vehicle based on the envelope area, in order to control the light emission. Method 300 may be carried out advantageously in conjunction with a device such as the control device from FIG. 4, for example.

FIG. 4 shows a schematic representation of a vehicle having a control device according to one exemplary embodiment of the present invention. Vehicle 400 has a vehicle camera 410, a navigation device 420, a control device 430 having a combining unit 440 as well as a setting unit 450, a drive device 460 and two headlights 470. Vehicle camera 410 and navigation device 420 are connected to control device 430, e.g., via at least one signal line. Drive device 460 is connected to control device 430, e.g., via at least one signal line. Thus, control device 430 is connected between vehicle camera 410 as well as navigation device 420 and drive device 460. Headlights 470 are connected to drive device 460, e.g., via at least one signal line. Thus, drive device 460 is connected between control device 430 and headlights 470. Even though it is not shown this way in FIG. 4, drive device 460 may also be a part of control device 430, or control device 430 may also be a part of drive device 460.

Vehicle camera 410 is designed to record at least one image of a road section in the direction of travel in front of vehicle 400, and to process and/or output it in the form of image information, image data or an image signal. Vehicle camera 410 may have image-processing electronics. In this case, vehicle camera 410 may also be designed to analyze the image information in order to generate lane information with respect to a course of the road on which vehicle 400 is presently located, and/or position information with regard to at least one other vehicle located in the course of the road. Vehicle camera 410 is able to output the image information, or the lane information and/or the position information, to control device 430.

Navigation device 420 may be provided optionally in vehicle 400. Instead of the navigation device, another mobile data-transmission device, e.g., an internet-capable mobile telephone, may also be provided. The navigation device may have map data or may access map data. Navigation device 420 may be designed to determine a position of vehicle 400. Navigation device 420 may also be designed to receive position data with regard to at least one other vehicle located in the course of the road, and to combine it with the map data in order to generate position information. Navigation device 420 may output the position information and sections of the map data (electronic horizon) to control device 430.

Control device 430 is designed to receive the lane information and the position information from vehicle camera 410 and, optionally, from navigation device 420. Control device 430 has combining unit 440 and setting unit 450. Control device 430 is designed to bring about a control of a light emission from headlights 470 of vehicle 400. In particular, control device 430 is designed to carry out a method for controlling a light emission from at least one headlight of a vehicle, such as the method according to FIG. 3, for instance.

Combining unit 440 is designed to combine the lane information with respect to the course of the road on which vehicle 400 is presently located, and the position information with regard to at least one other vehicle located in the course of the road, in order to ascertain an envelope area not to be illuminated around the at least one other vehicle. Combining unit 440 is also designed to output data representing the ascertained envelope area, to setting unit 450.

Setting unit 450 is designed to receive the data, which represents the ascertained envelope area, from combining unit 440. Setting unit 450 is designed to set a safety distance between light able to be emitted by headlights 470 of vehicle 400, and the at least one other vehicle based on the envelope area, in order to bring about a control of the light emission based on the safety distance.

Control device 430 is designed to output drive information representing the safety distance, to drive device 460.

Drive device 460 is designed to receive the drive information from control device 430. Drive device 460 is also designed to generate a control signal for controlling headlights 470. In generating the control signal, drive device 460 is able to take into account or use the drive information from control device 430. Thus, the control signal may contain the drive information. Drive device 460 is designed to output the control signal to headlights 470.

Headlights 470 are able to receive the control signal from drive device 460. The drive information, which is taken into account in the control signal, is able to cause the light emission to be controlled based on the safety distance. In this context, in particular, the safety distance between light able to be emitted by headlights 470 of vehicle 400, and the at least one other vehicle is able to be maintained, in order not to illuminate the envelope area.

FIG. 5 shows a camera image recorded by a vehicle camera. For example, the camera image may be taken by the vehicle camera from FIG. 4. Shown are a course of a road having lane markings 580, as well as one other vehicle 590 in the course of the road. Lane markings 580 are boundary lines such as a left and a right side line and a dividing middle line, i.e., a median strip. The course of the road in FIG. 5 represents an S-curve. Other vehicle 590 is a truck (TRK). In this case, other vehicle 590 may have become visible in the course of the road shortly before the instant the camera image was recorded. In particular, two front headlights of other vehicle 590 are recognizable. Thus, other vehicle 590 is an oncoming vehicle.

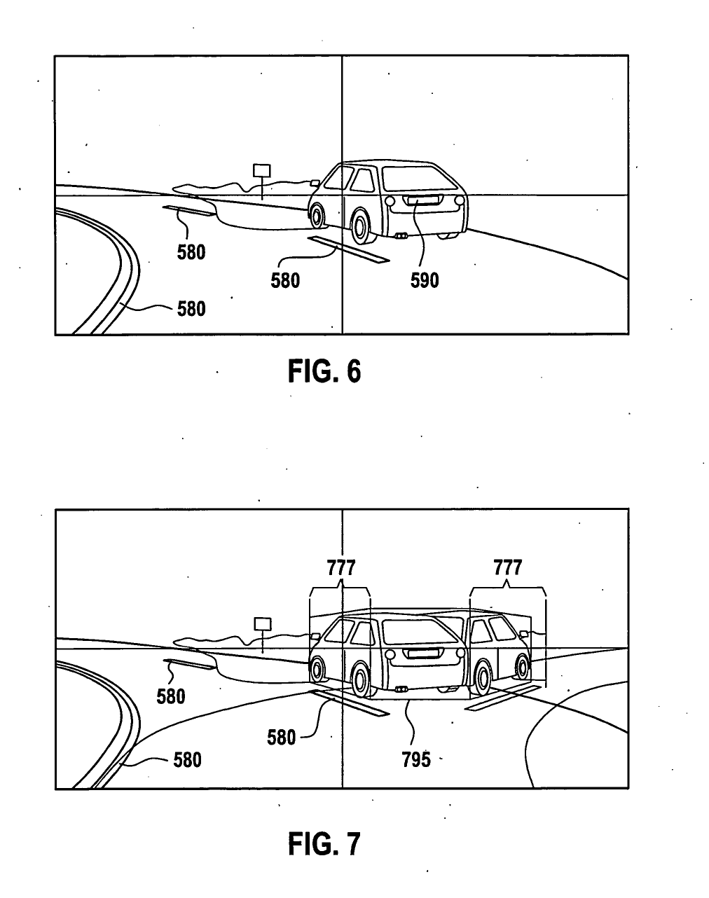

FIG. 6 shows a camera image recorded by a vehicle camera. For example, the camera image may be taken by the vehicle camera from FIG. 4. Shown are a course of a road with lane markings 580, as well as one other vehicle 590 in the course of the road. Lane markings 580 are boundary lines such as a left side line and a broken middle line, i.e., a median strip. The course of the road in FIG. 6 represents a left-hand curve. The camera image depicts a situation in which other vehicle 590 is being passed in a left-hand curve. In particular, two taillights or tail lamps of other vehicle 590, an illuminated license plate or license number of other vehicle 590, as well as a light cone of the front headlights of other vehicle 590 are recognizable. Thus, other vehicle 590 is a vehicle ahead which is being passed.

FIG. 7 shows a camera image recorded by a vehicle camera. The representation in FIG. 7 corresponds to the representation from FIG. 6, with the exception that a position 795 of the other vehicle, as well as a left section and a right section of a safety distance 777 are shown. Position 795 of the other vehicle may be determined from the image with the aid of the vehicle camera and/or image-processing electronics provided separately from it, and may be available, for example, in the form of position information. Safety distance 777 relates to a distance between light from at least one headlight of the vehicle in which the vehicle camera is located, and the other vehicle. Safety distance 777 may be ascertained in conjunction with the method from FIG. 3 and/or the control device from FIG. 4. Instead of a safety distance, a safety angle may also be used. According to the exemplary embodiment shown in FIG. 7, the left section and the right section of safety distance 777 are equal. In this context, it is noteworthy that for the course of the curve shown, the right section of safety distance 777 in particular could also be set smaller, but in the case of an unclear or unknown course of the road, both sections of safety distance 777 could also be enlarged.

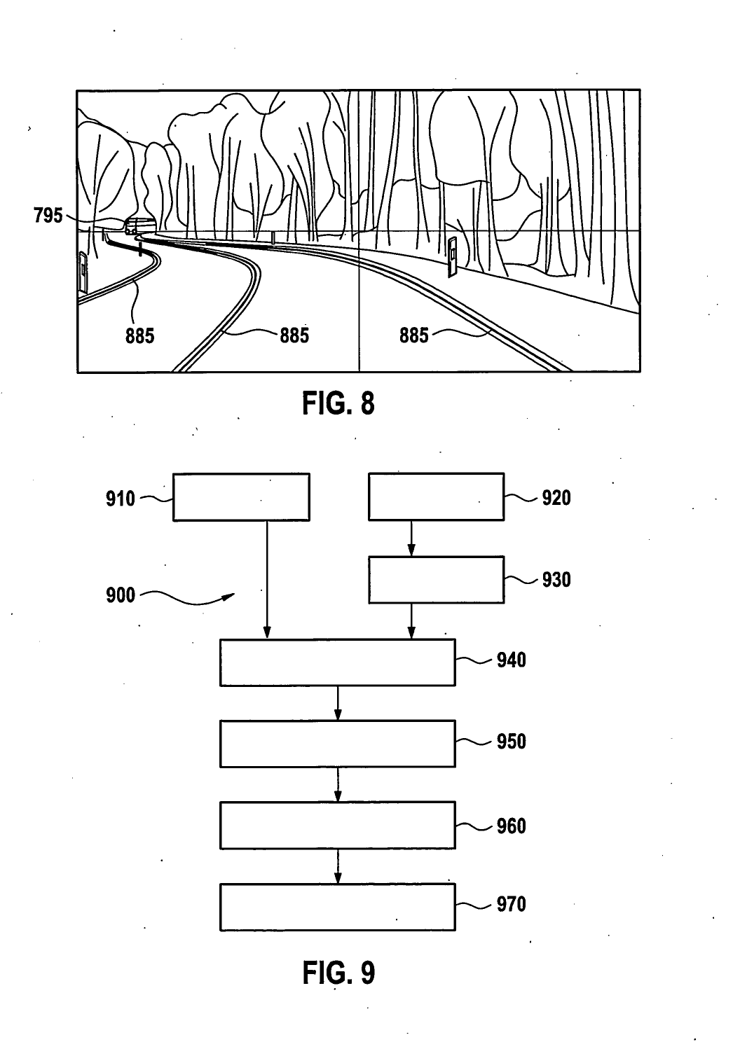

FIG. 8 shows a camera image recorded by a vehicle camera. The representation in FIG. 8 corresponds to the representation from FIG. 5, with the exception that a position 795 of the other vehicle, as well as lane courses 885 are shown. Position 795 of the other vehicle may be determined from the image with the aid of the vehicle camera and/or image-processing electronics provided separately from it, and may be available, for example, in the form of position information. Alternatively or additionally, position 795 may also come, for example, in the form of position information from a navigation device or the like. In this case, the position information may be determined using navigation data. Lane courses 885 are discernible as lines along the lane markings in the camera image. Lane courses 885 may be determined with the aid of the vehicle camera and, additionally or alternatively, with the aid of the navigation device, and may be available in the form of lane information, for instance.

FIG. 9 shows a flow chart of an algorithm 900 according to one exemplary embodiment of the present invention. Algorithm 900 may be part of a method for controlling the light emission from at least one headlight of a vehicle, e.g., the method from FIG. 3. The method from FIG. 3 may also be part of algorithm 900, for example. In step 910, information concerning objects detected by night is received from a vehicle camera, e.g., a video camera or perhaps a still-image camera. The objects may involve at least one other vehicle or its headlights. In step 920, lane information is received from the vehicle camera or video camera, and/or perhaps map data directly from a navigation device. In step 930, a (virtual) map is generated based on the lane information and/or map data. Step 930 as well as the map as such are optional. Instead of the map, the lane information may be used. In step 940, possible placements or alignments of the at least one other vehicle are ascertained on the map and/or with the lane information. In so doing, the knowledge of the approximate distance of the at least one other vehicle is advantageous, but not absolutely necessary. In step 950, the assumption is made that the at least one other vehicle is located in the lane, that is, is not transverse to the roadway. In step 960, a safety distance from all possible positions or directions of the at least one other vehicle is calculated on the map. In step 970, a safety distance optimized in this manner is set.

In summary, some of the principles underlying the present invention are explained with reference to FIGS. 3 through 9. The detection algorithm VDD (vehicle detection in the dark), for example, recognizes headlights of other vehicle 590 as points of light. The difficulty in this context is that the alignment of other vehicle 590 cannot be measured based on the points of light from the headlights, nor from the image position, i.e., position 795 in the image. However, knowledge about the alignment of other vehicle 590 is important in order to set lateral safety distance 777 correctly with respect to the detected headlights. Without knowledge of the alignment, safety distance 777 must be equal in both directions, so that no blinding occurs. If the course of the road is known based on lane courses 885, the alignment of other vehicle 590 may be estimated. Because the course of the road is known, at least the side of the safety distance of the light may be determined, e.g., the right section of safety distance 777 in FIG. 7. If the alignment of other vehicle 590 is able to be estimated with sufficient accuracy, safety distance 777 may be adjusted or set depending on foreshortening. Within simple curves, in principle, the alignment could also be estimated on the basis of the instantaneous radius of curve. For example, the instantaneous radius of curve may be calculated from the driving data of the vehicle such as speed, yaw rate and/or steering angle. However, in S-curves or beginnings and ends of curves, for instance, this is no longer possible. Depending upon how far the look forward needs to be, the use of data from the navigation device or the like also offers a solution.

Method 300 and control device 430 described use a video system that, first of all, detects the headlights of other vehicles, possibly also color, i.e., direction of travel, as well as the lanes or lane markings on the road. A glare-free high beam is also intended to function if no lane information is available. If the lane information is eliminated, a different or larger safety distance or safety angle is obtained, that is, a larger shadow area, since the safety distance or safety angle is set to be larger at one or both sides than when the lanes are visible. According to exemplary embodiments of the present invention, the use of the safety distance in conjunction with the lane detection thus permits a more accurate calculation and setting particularly of the horizontal safety distance, e.g., in the case of glare-free high beam by using the course of the road in order, for example, to increase the visual range.

The description above starts, by way of example, from the assumption of a video system. In principle, however, it does not need to involve a video system that detects other vehicles; for example, the use of radar (systems) is also possible. However, the employment of a video system presents itself, since greater distances, e.g., 1000 m or more, can and should be covered with it by night than with radar, with which roughly 250 m are able to be reached. A predictive lane detection is expedient, since beginnings and ends of curves may be detected in this manner, as well. The area covered by the lane detection may be relatively small, e.g., less than 100 m. Beginnings and ends of curves may be measured by a video system or, for example, may be ascertained from the map data of a navigation device for an even greater projection.

The exemplary embodiments described and illustrated in the figures are selected only by way of example. Different exemplary embodiments may be combined with each other completely or in terms of individual features. One exemplary embodiment may also be supplemented by features from another exemplary embodiment. Moreover, method steps according to the invention may be repeated and executed in a sequence other than that described.

What is claimed is:

1. A method for controlling a light emission from at least one headlight of a host vehicle, comprising:
combining at least lane information with respect to a course of a road and position information regarding at least one other vehicle located in the course of the road, in order to ascertain an envelope area not to be illuminated around the at least one other vehicle; and
setting, based upon at least the envelope area, a safety distance between (i) light able to be emitted from the at least one headlight of the host vehicle, and (ii) the at least one other vehicle, in order to control the light emission.

2. The method as recited in claim 1, wherein in the combining step, the envelope area is ascertained additionally based on an alignment of the at least one other vehicle relative to the host vehicle.

3. The method as recited in claim 2, wherein in the setting step, at least one lateral section of the safety distance located to the side of the at least one other vehicle is additionally set based on the alignment.

4. The method as recited in claim 2, wherein in the combining step, a digital representation of the course of the road is generated, and wherein the envelope area is ascertained using the digital representation.

5. The method as recited in claim 2, wherein in the combining step, potential placements of the at least one other vehicle are determined based on the lane information, and wherein the envelope area is ascertained using the potential placements.

6. The method as recited in claim 2, wherein at least one of the lane information and the position information is determined based on image data.

7. The method as recited in claim 2, wherein at least one of the lane information and the position information is determined based on navigation data.

8. The method as recited in claim 2, wherein at least one of the lane information and the position information is determined based on driving data of the vehicle.

9. The method as recited in claim 2, wherein in the setting step, the safety distance is set based on the envelope area and plausibility of the lane information.

10. The method as recited in claim 2, wherein the envelope area is ascertained as a function of at least one of a quality and plausibility of the lane information.

11. The method as recited in claim 2, wherein the lane information with respect to the course of the road is ascertained empirically, and wherein the position information with regard to the at least one other vehicle located in the course of the road is received from a source external to the host vehicle.

12. The method as recited in claim 2, further comprising:
one of (i) checking the plausibility of the position information based on movement data of the other vehicle, or (ii) adjusting the position information based on movement data of the other vehicle.

13. A device for controlling a light emission from at least one headlight of a host vehicle, comprising:
means for combining at least lane information with respect to a course of a road and position information regarding at least one other vehicle located in the course of the road, in order to ascertain an envelope area not to be illuminated around the at least one other vehicle; and
means for setting, based upon at least the envelope area, a safety distance between (i) light able to be emitted from the at least one headlight of the host vehicle, and (ii) the at least one other vehicle, in order to control the light emission.

14. A non-transitory computer-readable data storage medium storing a computer program having program codes which, when executed on a computer, performs a method for controlling a light emission from at least one headlight of a host vehicle, the method comprising:
combining at least lane information with respect to a course of a road and position information regarding at least one other vehicle located in the course of the road, in order to ascertain an envelope area not to be illuminated around the at least one other vehicle; and
setting, based upon at least the envelope area, a safety distance between (i) light able to be emitted from the at least one headlight of the host vehicle, and (ii) the at least one other vehicle, in order to control the light emission.
